(19) United States
(12) Patent Application Publication
(10) Pub. No.: US 2013/0224608 A1
(43) Pub. Date: Aug. 29, 2013

(54) POSITIVE ELECTRODE ACTIVE MATERIAL FOR SECONDARY BATTERY

(71) Applicants: Hideaki Sasaki, Tokyo (JP); Takehiro Noguchi, Tokyo (JP)

(72) Inventors: Hideaki Sasaki, Tokyo (JP); Takehiro Noguchi, Tokyo (JP)

(73) Assignee: NEC CORPORATION, Tokyo (JP)

(21) Appl. No.: 13/883,662

(22) PCT Filed: Nov. 16, 2011
(86) PCT No.: PCT/JP2011/076366

§ 371 Date: May 6, 2013

(30) Foreign Application Priority Data
Dec. 13, 2010 (JP) 2010-276836

(51) Int. Cl. H01M 4/505; H01M 4/52

(52) U.S. Cl. CPC H01M 4/505; H01M 4/52
USPC 429/341; 429/224; 429/223; 429/220; 429/344; 252/182.1

(57) ABSTRACT

A positive electrode active material having a charge and discharge range of 4.5 V or more with respect to lithium metal and used for a secondary battery excellent in charge and discharge characteristics and cycle characteristics is provided. The positive electrode active material B for a secondary battery according to the exemplary embodiment is obtained by subjecting a positive electrode active material A for a secondary battery having a charge and discharge range of 4.5 V or more with respect to lithium metal to coupling treatment with a coupling agent containing at least fluorine. Further, the positive electrode active material B for a secondary battery according to the exemplary embodiment has a film at least containing fluorine on at least a part of a surface of a positive electrode active material A for a secondary battery having a charge and discharge range of 4.5 V or more with respect to lithium metal. The exemplary embodiment can provide a positive electrode active material having a charge and discharge range of 4.5 V or more with respect to lithium metal and used for a secondary battery excellent in charge and discharge characteristics and cycle characteristics.

### TECHNICAL FIELD

The exemplary embodiment relates to a positive electrode active material for a secondary battery.

### BACKGROUND ART

A lithium ion secondary battery has a smaller volume and a higher weight capacity density than a secondary battery such as an alkaline storage battery and can produce high voltage. Therefore, a lithium ion secondary battery is widely employed as a power source for small equipment. A lithium ion secondary is, for example, widely used as a power source for mobile devices such as a cellular phone and a notebook personal computer. Further, in recent years, a lithium ion secondary battery is expected for applications in a large-sized battery, which has a large capacity and for which a long life is required, for example, for an electric vehicle (EV) and a power storage field, from the rise of consciousness to the concerns to environmental problems and energy saving, besides the small-sized mobile device applications.

At present, in a commercially available lithium ion secondary battery, a material based on LiMO₂ (M is at least one of Co, Ni, and Mn) having a layer structure or LiMn₂O₄ having a spinel structure is used as a positive electrode active material. Further, a carbon material such as graphite is used as a negative electrode active material. A charge and discharge range of 4.2 V or less with respect to lithium metal is mainly used for the operating voltage of such a secondary battery. Such a positive electrode active material having a charge and discharge range of less than 4.5 V with respect to lithium metal is called a 4 V-class positive electrode.

On the other hand, when a material obtained by replacing a part of Mn of LiMn₂O₄ with Ni or the like is used as a positive electrode active material, such a material is known to show a high charge and discharge range of 4.5 to 4.8 V with respect to lithium metal. Specifically, in a spinel compound such as LiNi_{0.5}Mn_{1.5}O₄, the oxidation-reduction between Mn³⁺ and Mn⁴⁺ is not used, but Mn is present in the state of Mn⁴⁺ and the oxidation-reduction between Ni²⁺ and Ni⁴⁺ is used. Therefore, such a compound shows a high operating voltage of 4.5 V or more with respect to lithium metal. Such a positive electrode active material having a charge and discharge range of 4.5 V or more with respect to lithium metal is called a 5 V-class positive electrode. Since the 5 V-class positive electrode can achieve improvement in energy density by increasing voltage, it is expected as a promising material of a positive electrode active material.

However, an electrolytic solution is liable to be oxidatively decomposed as the potential of the positive electrode increases. Further, ions of metals such as Mn and Ni are liable to be eluted from the positive electrode. Therefore, particularly in a high-temperature environment of 40° C. or more, there have been problems such as the generation of a large amount of gas and the reduction of charge and discharge characteristics and cycle characteristics.

Means to prevent the decomposition of an electrolytic solution and the elution of metal ions includes a method in which the surface of a positive electrode active material is subjected to surface modification. For example, Patent Literatures 1 and 2 disclose a method of improving cycle characteristics by subjecting the surface of a positive electrode active material to surface modification with a silane coupling agent.

### CITATION LIST

### Patent Literature

Patent Literature 1: JP2002-83596A
Patent Literature 2: JP11-354104A

### SUMMARY OF INVENTION

### Technical Problem

However, Patent Literature 2 describes only examples in which a 4 V-class positive electrode is used. Further, also in Patent Literature 1 in which a 5 V-class positive electrode is described, charge and discharge characteristics and cycle characteristics are not sufficiently improved.

When a 5 V-class positive electrode is used, an improvement in cycle characteristics is not necessarily observed for a silane coupling agent effective in a 4 V-class positive electrode, but, conversely, the silane coupling agent itself may be oxidatively decomposed or the like to reduce charge and discharge characteristics. Patent Literatures 1 and 2 have not disclosed at all a coupling agent which is particularly effective in a 5 V-class positive electrode.

An object of the exemplary embodiment is to provide a positive electrode active material having a charge and discharge range of 4.5 V or more with respect to lithium metal and used for a secondary battery excellent in charge and discharge characteristics and cycle characteristics.

### Solution to Problem

The positive electrode active material B for a secondary battery according to the exemplary embodiment is obtained by subjecting a positive electrode active material A for a secondary battery having a charge and discharge range of 4.5 V or more with respect to lithium metal to coupling treatment with a coupling agent containing at least fluorine.

The positive electrode active material B for a secondary battery according to the exemplary embodiment has a film at least containing fluorine on at least a part of a surface of a positive electrode active material A for a secondary battery having a charge and discharge range of 4.5 V or more with respect to lithium metal.

The positive electrode for a secondary battery according to the exemplary embodiment includes the positive electrode active material B for a secondary battery according to the exemplary embodiment.

The secondary battery according to the exemplary embodiment includes the positive electrode for a secondary battery according to the exemplary embodiment.

The method for producing the positive electrode active material B for a secondary battery according to the exemplary embodiment includes: mixing a positive electrode active material A for a secondary battery having a charge and discharge range of 4.5 V or more with respect to lithium metal with a treatment solution containing a coupling agent containing at least fluorine; and drying the mixture.

### Advantageous Effect of Invention

The exemplary embodiment can provide a positive electrode active material having a charge and discharge range of 4.5 V or more with respect to lithium metal and used for a secondary battery excellent in charge and discharge characteristics and cycle characteristics.

### BRIEF DESCRIPTION OF DRAWINGS

FIG. 1 is a sectional view of an example of the secondary battery according to the exemplary embodiment.

FIG. 2 is a view showing the first discharge capacity and the charge and discharge efficiency in Example 1 and Comparative Examples 1 to 4.

### DESCRIPTION OF EMBODIMENTS

### [Positive Electrode Active Material B for Secondary Battery]

The positive electrode active material B for a secondary battery according to the exemplary embodiment is obtained by subjecting a positive electrode active material A for a secondary battery having a charge and discharge range of 4.5 V or more with respect to lithium metal to coupling treatment with a coupling agent containing at least fluorine.

### (Positive Electrode Active Material A for Secondary Battery)

The positive electrode active material A for a secondary battery can be used as a positive electrode active material before being subjected to coupling treatment with a coupling agent containing fluorine. In the exemplary embodiment, a positive electrode active material having a charge and discharge range of 4.5 V (vs. Li/Li⁺) or more with respect to lithium metal is used as the positive electrode active material A for a secondary battery.

For example, a lithium manganese composite oxide represented by the following formula (II) can be used as the positive electrode active material A for a secondary battery.

Liₐ(MₓMn_{2-x-y}Y_{y})(O_{4-w}Z_{w}) (II)

In the formula (II), 0.5≦x≦1.2, 0≦y, x+y<2, 0≦a≦1.2, and 0≦w≦1; M is at least one selected from the group consisting of Co, Ni, Fe, Cr, and Cu; Y is at least one selected from the group consisting of Li, B, Na, Mg, Al, Ti, Si, K, and Ca; and Z is at least one of F and Cl.

In the formula (II), x is preferably 0.5≦x≦0.8, more preferably 0.5≦x≦0.7; y is preferably 0≦y≦0.2, more preferably 0≦y≦0.1; x+y is preferably x+y≦1.2, more preferably x+y≦1; a is preferably 0.8≦a≦1.2, more preferably 0.9≦a≦1.1; and w is preferably 0≦w≦0.5, more preferably 0≦w≦0.1.

In the formula (II), M preferably includes at least Ni. Further, M is preferably at least one selected from the group consisting of Ni, Co, and Fe, and M is more preferably Ni. In the formula (II), Y is an optionally contained element, and when Y is contained, Y is preferably Ti.

In the formula (II), Z is an optionally contained element.

Note that it is possible to determine whether the positive electrode active material A for a secondary battery has a charge and discharge range of 4.5 V (vs. Li/Li⁺) or more with respect to lithium metal or not from the discharge curve of a secondary battery using the target positive electrode active material A for a secondary battery.

The average particle size of the positive electrode active material A for a secondary battery is preferably 5 to 25 μm. When the average particle size of the positive electrode active material A for a secondary battery is 5 μm or more, an increase in the generation of gas, caused by the reaction between positive electrode active material B for a secondary battery with an electrolytic solution, due to the increase in the contact area with the electrolytic solution can be suppressed. Further, a reduction in cycle characteristics due to the increase in the cell resistance with the increase in the elution volume of metal ions can be suppressed. On the other hand, when the average particle size of the positive electrode active material A for a secondary battery is 25 μm or less, a reduction in rate characteristics due to the increase in the diffusion length of lithium in particles can be suppressed. Note that the average particle size refers to a value measured by a laser diffraction scattering method (micro-track method).

The specific surface area of the positive electrode active material A for a secondary battery is preferably 0.2 to 1.2 m²/g. When the specific surface area of the positive electrode active material A for a secondary battery is 0.2 m²/g or more, satisfactory rate characteristics will be obtained because of a sufficient reaction surface area. On the other hand, when the specific surface area of the positive electrode active material A for a secondary battery is 1.2 m²/g or less, satisfactory high temperature cycle characteristics will be obtained. Note that the specific surface area refers to a value measured by a BET method.

A raw material is not particularly limited in the preparation of the positive electrode active material A for a secondary battery. For example, Li₂CO₃, LiOH, Li₂O, Li₂SO₄ and the like can be used as a Li raw material. Among these, Li₂CO₃ and LiOH are preferred. Various Mn oxides such as electrolytic manganese dioxide (EMD), Mn₂O₃, Mn₃O₄, and CMD (chemical manganese dioxide), MnCO₃, MnSO₄ and the like can be used as a Mn raw material. NiO, Ni(OH), NiSO₄, Ni(NO₃)₂ and the like can be used as a Ni raw material. Fe₂O₃, Fe₃O₄, Fe(OH)₂, FeOOH, and the like can be used as a Fe raw material. Oxides, carbonates, hydroxides, sulfides, nitrates, and the like of other elements can be used as raw materials of other elements. These may be used singly or in combination of two or more.

A method for preparing the positive electrode active material A for a secondary battery is not particularly limited, but it can be prepared, for example, by the following method. These raw materials are weighed and mixed such that the target metal composition ratio is obtained. The mixing can be conducted by pulverizing and mixing using a ball mill, a jet mill or the like. The resulting mixed powder is calcined in the air or in oxygen at a temperature from 400° C. to 1200° C. to obtain the positive electrode active material A for a secondary battery. A higher calcining temperature is better for diffusing each element, but if the calcining temperature is too high, oxygen deficiency may occur to reduce battery characteristics. Therefore, the calcining temperature is preferably from 450° C. to 1000° C.

Note that the composition ratio of each element in the formula (II) is a value calculated from the charged amount of the raw material of each element.

### (Coupling Agent Containing Fluorine)

In the exemplary embodiment, the positive electrode active material B for a secondary battery is obtained by subjecting the positive electrode active material A for a secondary battery to coupling treatment with a coupling agent containing at least fluorine. A film at least containing fluorine on at least a part of a surface of the positive electrode active material A for a secondary battery can be formed by subjecting the positive electrode active material A for a secondary battery to coupling treatment with a coupling agent containing fluorine. This can improve the oxidation resistance to prevent the decomposition of an electrolytic solution and the elution of metal ions from the positive electrode for a secondary battery. Examples of the coupling agent containing fluorine include a silane coupling agent containing fluorine, a aluminum-based coupling agent containing fluorine, and a titanium-based coupling agent containing fluorine.

Among these, it is preferred to use a silane coupling agent having a fluorinated alkyl group represented by the following formula (I) as the coupling agent containing fluorine.

CF₃(CF₂)ₙ(CH₂)₂—Si—(OR)₃ (I)

In formula (I), n is an integer of 0 to 10, and R is —(CH₂)ₘCH₃, wherein m is an integer of 0 to 2.

Here, the hydrolyzable group (—OR) in the silane coupling agent produces a hydroxy group (—OH) by hydrolysis. The hydroxy group can modify the surface of the positive electrode active material A for a secondary battery because it is subjected to dehydration condensation with the hydroxy group on the surface of the positive electrode active material A for a secondary battery to form a covalent bond, thus forming a strong, fine film containing fluorine and silicon. In the above formula (I), since the molecular weight increases as the number (n) of the CF₂ groups is increased, the amount of the coupling agent required for forming a monomolecular layer on the surface of the positive electrode active material A for a secondary battery is increased. Therefore, even if the treatment amount is the same, the coverage rate tends to be reduced as the molecular weight increases. Further, the number (n) of the CF₂ groups is preferably n=0 to 10, more preferably n=0 to 5, in terms of the fact that these are relatively easily available.

Such a coupling agent containing fluorine may be used singly or in combination of two or more.

The method for subjecting the positive electrode active material A for a secondary battery to coupling treatment with a coupling agent containing fluorine is not particularly limited. For example, the coupling treatment can be carried out by preparing a treatment solution in which a coupling agent containing fluorine is dissolved in a mixed solvent of ethanol and water, mixing a positive electrode active material A for a secondary battery with the treatment solution to obtain a slurry, and drying the slurry (wet method). There may be employed a method in which a powder of the positive electrode active material A for a secondary battery is sprayed and coated with the above treatment solution with being stirred the powder; and then the coated powder is dried. The wet method is preferred in terms of the fact that the surface of the positive electrode active material A for a secondary battery can be uniformly coated. An organic acid such as acetic acid may be added to the treatment solution for pH adjustment.

The treatment amount of the coupling agent containing fluorine to the positive electrode active material A for a secondary battery is preferably 0.1 to 5% by mass, more preferably 0.2 to 2% by mass, further preferably 0.5 to 1.5% by mass, relative to the mass of the positive electrode active material B for a secondary battery. When the treatment amount is 0.1% by mass or more, the effect of coupling treatment can sufficiently be obtained. On the other hand, when the treatment amount is 5% by mass or less, the transfer of Li ions is not disturbed; an increase in resistance can be suppressed; and a reduction in battery characteristics can be prevented.

Note that the lower limit of the treatment amount can be defined by the amount required for forming a monomolecular layer at least on the whole surface of the positive electrode active material A for a secondary battery. This can be calculated from the minimum coverage area (m²/g) of the silane coupling agent. The minimum coverage area (X) is the area that can be covered with 1 g of a silane coupling agent when the monomolecular covering is assumed, and can be determined from the following formula: X=6.02×10²³×13×10⁻²⁰/molecular weight of silane coupling agent. The treatment amount B (%) of the silane coupling agent required for the monomolecular covering of the positive electrode active material A for a secondary battery having a specific surface area of S (m²/g) is determined from the following formula: B=S/X×100 (%). From the treatment amount B (%), it is possible to calculate how many molecular layer coverings the treatment amount corresponds to, using the formula. The covering layer is preferably one molecular layer or more and 10 molecular layers or less.

### [Positive Electrode for Secondary Batteries]

The positive electrode for a secondary battery according to the exemplary embodiment includes the positive electrode active material B for a secondary battery according to the exemplary embodiment.

The positive electrode for a secondary battery according to the exemplary embodiment is obtained, for example, by forming a positive electrode active material layer containing the positive electrode active material B for a secondary battery on at least one surface of a positive electrode current collector. The positive electrode active material layer contains, for example, a positive electrode active material B for a secondary battery, a binder, and a conductive aid.

Examples of the binder include polyvinylidene fluoride (PVDF) and an acrylic polymer. These may be used singly or in combination of two or more. Carbon materials such as carbon black, granular graphite, scale-like graphite, and carbon fiber can be used as the conductive aid. These may be used singly or in combination of two or more. In particular, it is preferred to use carbon black having low crystallinity. Aluminum, stainless steel, nickel, titanium, alloys thereof or the like can be used as the positive electrode current collector.

The positive electrode for a secondary battery according to the exemplary embodiment can be prepared, for example, by dispersing and kneading a positive electrode active material B for a secondary battery, a binder, and a conductive aid in a solvent such as N-methyl-2-pyrrolidone (NMP) in a predetermined blending amount to obtain a slurry and applying the slurry to a positive electrode current collector to form a positive electrode active material layer. The obtained positive electrode for a secondary battery can also be compressed by a method such as a roll press to be adjusted to a suitable density.

### [Secondary Battery]

The secondary battery according to the exemplary embodiment includes the positive electrode for a secondary battery according to the exemplary embodiment. The secondary battery according to the exemplary embodiment includes, for example, the positive electrode for a secondary battery according to the exemplary embodiment, a negative electrode containing a negative electrode active material capable of absorbing and releasing lithium, and a nonaqueous electrolytic solution.

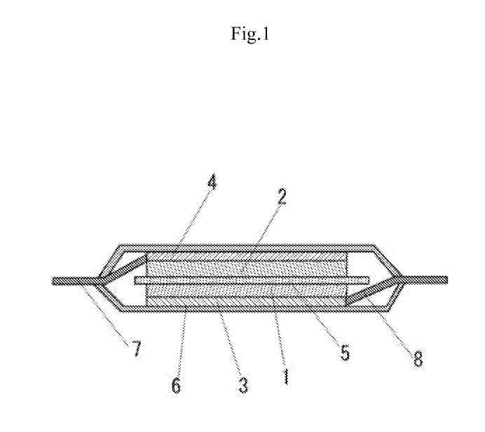

FIG. 1 shows a laminate type lithium ion secondary battery as an example of the secondary battery according to the exemplary embodiment. The shown secondary battery includes a positive electrode containing a positive electrode active material layer 1 containing a positive electrode active material B for a secondary battery and a positive electrode current collector 3, a negative electrode containing a negative electrode active material layer 2 containing a negative electrode active material capable of absorbing and releasing lithium and a negative electrode current collector 4, and a separator 5 sandwiched between the positive and negative electrodes. The positive electrode current collector 3 is connected with a positive electrode lead terminal 8, and the negative electrode current collector 4 is connected with a negative electrode lead terminal 7. A laminated outer package 6 is used for an outer package, and the inner part of the secondary battery is filled with a nonaqueous electrolytic solution.

### (Nonaqueous Electrolytic Solution)

A solution in which an electrolyte including a lithium salt is dissolved in a nonaqueous solvent can be used as a nonaqueous electrolytic solution.

Examples of the lithium salt include a lithium imide salt, LiPF₆, LiAsF₆, LiAlCl₄, LiClO₄, LiBF₄, and LiSbF₆. Among these, LiPF₆ and LiBF₄ are preferred. Examples of the lithium imide salt include LiN(CₖF₂ₖ₊₁SO₂)(CₘF₂ₘ₊₁SO₂), wherein k and m are each independently 1 or 2. The lithium salt may be used singly or in combination of two or more.

Examples of the nonaqueous solvent which can be used include at least one organic solvent selected from the group consisting of cyclic carbonates, chain carbonates, aliphatic carboxylates, γ-lactones, cyclic ethers, and chain ethers. Examples of the cyclic carbonates include propylene carbonate (PC), ethylene carbonate (EC), butylene carbonate (BC), and derivatives thereof (including fluorinated compounds). Generally, since a cyclic carbonate has high viscosity, an chain carbonate is mixed and used in order to reduce the viscosity. Examples of the chain carbonates include dimethyl carbonate (DMC), diethyl carbonate (DEC), ethyl methyl carbonate (EMC), dipropyl carbonate (DPC), and derivatives thereof (including fluorinated compounds). Examples of the aliphatic carboxylates include methyl formate, methyl acetate, ethyl propionate, and derivatives thereof (including fluorinated compounds). Examples of the γ-lactones include y-butyrolactone and derivatives thereof (including fluorinated compounds). Examples of the cyclic ethers include tetrahydrofuran, 2-methyltetrahydrofuran, and derivatives thereof (including fluorinated compounds). Examples of the chain ethers include 1,2-diethoxyethane (DEE), ethoxymethoxyethane (EME), diethyl ether, and derivatives thereof (including fluorinated compounds). Further, examples of other nonaqueous solvents which can also be used include dimethyl sulfoxide, 1,3-dioxolane, formamide, acetamide, dimethylformamide, acetonitrile, propylnitrile, nitromethane, ethyl monoglyme, triester phosphate, trimethoxymethane, dioxolane derivatives, sulfolane, methyl sulfolane, 1,3-dimethyl-2-imidazolidinone, 3-methyl-2-oxazolidinone, propylene carbonate derivatives, tetrahydrofuran derivatives, ethyl ether, 1,3-propane sultone, anisole, N-methyl pyrrolidone, and derivatives thereof (including fluorinated compounds).

### (Fluorinated Solvent)

In particular, the nonaqueous electrolytic solution preferably contains a fluorinated solvent. Since a fluorinated solvent generally has a high oxidation resistance, it can suppress the decomposition reaction of a nonaqueous electrolytic solution even when a 5 V-class positive electrode with a high potential is used. Further, according to the exemplary embodiment, a film containing at least fluorine is formed on at least a part of a surface of the positive electrode active material B for a secondary battery by the coupling treatment with a coupling agent containing fluorine; and since the compatibility (wettability) between the film and a fluorinated solvent is high, the rate characteristics are improved. Further, since the secondary battery hardly results in liquid shortage even when the amount of the nonaqueous electrolytic solution is reduced by the decomposition of the nonaqueous electrolytic solution, the cycle characteristics are improved.

The fluorinated solvent is not particularly limited, but a fluorinated ether or a fluorinated phosphoric ester is preferred in terms of oxidation resistance and lithium ion conductivity. Examples of the fluorinated ether include, for example, H(CF₂)₂CH₂O(CF₂)₂H, CF₃(CF₂)₄OC₂H₅, and CF₃CH₂OCH₃. These may be used singly or in combination of two or more.

The concentration of the fluorinated solvent in the nonaqueous electrolytic solution is preferably 5 to 30% by volume. When the concentration of the fluorinated solvent is within the range as described above, sufficient oxidation resistance and lithium ion conductivity can be obtained. The concentration of the fluorinated solvent is more preferably 10 to 20% by volume.

### (Negative Electrode Active Material)

A material capable of absorbing and releasing lithium can be used as the negative electrode active material. For example, carbon materials such as graphite and amorphous carbon can be used. Graphite is preferably used in terms of energy density. Further, examples of the negative electrode active material which can be used also include materials forming alloys with Li such as Si, Sn, and Al, Si oxides, Si composite oxides containing Si and metal elements other than Si, Sn oxides, Sn composite oxides containing Sn and metal elements other than Sn, Li₄Ti₅O₁₂, and composite materials in which these materials are covered with carbon. The negative electrode active material may be used singly or in combination of two or more.

### (Negative Electrode)

The negative electrode is obtained, for example, by forming a negative electrode active material layer on at least one surface of a negative electrode current collector. The negative electrode active material layer includes, for example, a negative electrode active material, a binder, and a conductive aid.

Examples of the binder include polyvinylidene fluoride (PVDF), an acrylic polymer, and a styrene-butadiene rubber (SBR). When an aqueous binder such as an SBR emulsion is used, a thickener such as carboxymethyl cellulose (CMC) can also be used. These may be used singly or in combination of two or more. Carbon materials such as carbon black, granular graphite, scale-like graphite, and carbon fiber can be used as the conductive aid. These may be used singly or in combination of two or more. Copper, stainless steel, nickel, titanium, alloys thereof or the like can be used as the negative electrode current collector.

The negative electrode can be prepared, for example, by dispersing and kneading a negative electrode active material, a binder, and a conductive aid in a solvent such as N-methyl-2-pyrrolidone (NMP) in a predetermined blending amount to obtain a slurry and applying the slurry to a current collector to form a negative electrode active material layer. The obtained negative electrode can also be compressed by a method such as a roll press to be adjusted to a suitable density.

### (Separator)

Examples of the separator which can be used include porous films of polyolefins such as polypropylene and polyethylene, fluororesins, and the like.

### (Outer Package)

Examples of the outer package which can be used include a can such as a coin type can, a square type can, and a cylinder type can, and a laminated outer package. However, a laminated outer package made of a flexible film including a laminate of a synthetic resin and metal foil is preferably used in terms of allowing the reduction of weight and achieving an improvement in battery energy density. Since a laminate type secondary battery using the laminated outer package is also excellent in heat release, it can be suitably used as a battery for vehicles such as an electric vehicle.

### EXAMPLES

Examples of the exemplary embodiment will be described in detail below, but the exemplary embodiment is not limited to the following Examples.

### Example 1

### (Preparation of Positive Electrode Active Material B for Secondary Battery)

A LiNi_{0.5}Mn_{1.5}O₄ powder (average particle size (D50): 10 μm specific surface area: 0.5 m²/g) was prepared as a positive electrode active material A for a secondary battery. 3,3,3-Trifluoropropyl trimethoxysilane (CF₃CH₂CH₂Si(OCH₃)₃) was dissolved in a mixed solvent of ethanol and water (ethanol:water=9:1 (volume ratio)) to prepare a treatment solution containing 2% by mass of a coupling agent. The treatment solution was thoroughly mixed with the positive electrode active material A for a secondary battery to obtain a slurry, which was dried at 50° C. to remove most of the solvent. Then, the resulting mixture was dried at 120° C. for 1 hour, thereby preparing a positive electrode active material B for a secondary battery. Note that the treatment amount of the coupling agent to the positive electrode active material A for a secondary battery was 0.7% by mass relative to the mass of the positive electrode active material B for a secondary battery.

### (Preparation of Positive Electrode for Secondary Battery)

A positive electrode slurry was prepared by uniformly dispersing, in NMP, the positive electrode active material B for a secondary battery, PVDF as a binder, and carbon black as a conductive aid, in a mass ratio of 93:4:3. The positive electrode slurry was applied to aluminum foil having a thickness of 20 μm used as a positive electrode current collector. Then, the coated aluminum foil was dried at 125° C. for 10 minutes to allow NMP to evaporate to thereby prepare a positive electrode for a secondary battery. Note that the mass of the positive electrode active material layer per unit area after drying was 0.018 g/cm².

### (Preparation of Negative Electrode)

A negative electrode slurry was prepared by uniformly dispersing, in NMP, graphite powder (average particle size (D50): 20 μm specific surface area: 1.2 m²/g) as a negative electrode active material and PVDF as a binder, in a mass ratio of 95:5. The negative electrode slurry was applied to copper foil having a thickness of 15 μm used as a negative electrode current collector. Then, the coated copper foil was dried at 125° C. for 10 minutes to allow NMP to evaporate to thereby form a negative electrode active material layer. Then, the negative electrode active material layer was pressed to prepare a negative electrode. Note that the mass of the negative electrode active material layer per unit area after drying was 0.008 g/cm².

### (Nonaqueous Electrolytic Solution)

In a nonaqueous solvent in which EC and DMC are mixed in a ratio of EC:DMC=40:60 (% by volume), 1 mol/L of LiPF₆ was dissolved as an electrolyte, and thereto 2.5% by mass of vinylene carbonate (VC) was mixed as an additive. The resulting solution was used as a nonaqueous electrolytic solution.

### (Preparation of Laminated Type Secondary Battery)

The prepared positive electrode and negative electrode for a secondary battery were each cut into a size of 5 cm×6 cm, in which a portion (5 cm×1 cm) on an edge was a portion where the electrode active material layer was not formed (uncoated portion) for connecting a tab, and the other portion (5 cm×5 cm) was a portion where the electrode active material layer was formed (coated portion). A positive electrode tab made from aluminum having a width of 5 mm, a length of 3 cm, and a thickness of 0.1 mm was ultrasonically welded to the uncoated portion of the positive electrode for a secondary battery by 1 cm in length. Similarly, a negative electrode tab made from nickel having the same size as the positive electrode tab was ultrasonically welded to the uncoated portion of the negative electrode. The negative electrode and the positive electrode for a secondary battery were arranged on both sides of a separator containing polyethylene and polypropylene and having a size of 6 cm×6 cm so that the electrode active material layers may overlap with each other with the separator in between, thus preparing an electrode laminate. Three edges of two aluminum laminate films each having a size of 7 cm×10 cm, excluding one longer edge thereof, were heat sealed by a width of 5 mm to prepare a bag-shaped laminated outer package. The electrode laminate was inserted into the laminated outer package so that the electrode laminate might be positioned 1 cm away from one of the shorter edges of the laminated outer package. The laminate type secondary battery was prepared by pouring 0.2 g of the nonaqueous electrolytic solution, allowing the electrode laminate to be vacuum impregnated with the nonaqueous electrolytic solution, and then heat sealing the opening under reduced pressure to seal the opening by a width of 5 mm.

### (First Charge and Discharge)

The prepared laminate type secondary battery was charged to 4.8 V at a 12-mA constant current corresponding to 5-hour rate (0.2 C) at 20° C. Subsequently, it was subjected to a 4.8-V constant-voltage charge for 8 hours in total and then subjected to a constant-current discharge to 3.0 V at a 60-mA constant current corresponding to 1-hour rate (1 C). The value in which the discharge capacity (mAh) at this time was divided by the mass (g) of the positive electrode active material B for a secondary battery contained in the positive electrode for a secondary battery was defined as a first discharge capacity (mAh/g) of the positive electrode active material B for a secondary battery. Further, the ratio of the discharge capacity to the charge capacity (discharge capacity/charge capacity×100) was calculated as a charge and discharge efficiency (%). The results are shown in Table 1.

### (Cycle Test)

The laminate type secondary battery having completed the first charge and discharge was charged to 4.8 V at 1 C. Subsequently, the charged battery was subjected to a 4.8-V constant-voltage charge for 2.5 hours in total and then subjected to a constant-current discharge to 3.0 V at 1 C. This charge and discharge cycle was repeated 50 times at 45° C. The ratio of the discharge capacity after 50 cycles to the first discharge capacity was calculated as a capacity retention rate (%). The results are shown in Table 1.

### Examples 2 to 18, Comparative Examples 1 to 10

Secondary batteries were prepared in the same manner as in Example 1 except that the positive electrode active materials, coupling agents, and nonaqueous solvents which are shown in Table 1 were used in amounts as shown in Table 1, and the resulting secondary batteries were evaluated. The results are shown in Table 1. In Table 1, FE1 represents H(CF₂)₂CH₂O(CF₂)₂H; FE2 represents CF₃(CF₂)₄OC₂H₅; and FE3 represents CF₃CH₂OCH₃.

Note that, in Comparative Examples 1 and 5 to 9, the positive electrode active material was not subjected to coupling treatment with a coupling agent. Further, in Example 5 and Comparative Example 5, a LiNi_{0.5}Mn_{1.35}Ti_{0.15}O₄ powder (average particle size (D₅₀): 15 μm, specific surface area: 0.5 m²/g) was used. In Example 6 and Comparative Example 6, a LiNi_{0.4}Co_{0.2}Mn_{1.4}O₄ powder (average particle size (D₅₀): 15 μm specific surface area: 0.5 m²/g) was used. In Example 7 and Comparative Example 7, a LiNi_{0.45}Fe_{0.1}Mn_{1.45}O₄ powder (average particle size (D₅₀): 13 μm specific surface area: 0.5 m²/g) was used. Furthermore, in Comparative Examples 9 and 10, lithium manganate (LiMn₂O₄) which is one of the 4 V-class positive electrodes was used as a positive electrode active material instead of the positive electrode active material A for a secondary battery which is a 5 V-class positive electrode; and the upper limit voltage was changed to 4.2 V, and the current value corresponding to 1-hour rate (1 C) was changed to 50 mA.

In Examples 8 to 10 and 16 to 18, and in Comparative Example 8, the evaluation of rate characteristics was also performed by the following methods, as the evaluation of battery characteristics. The secondary battery having completed the first charge and discharge was charged to 4.8 V at 1 C at 20° C. Subsequently, it was subjected to a 4.8-V constant-voltage charge for 2.5 hours in total and then subjected to a constant-current discharge to 3.0 V at 2 C. Subsequently, it was again subjected to a constant-current discharge to 3.0 V at 0.2 C. The percentage (%) of the discharge capacity at 2 C was determined as the rate characteristics, wherein the total value of the discharge capacity at 2 C and the discharge capacity at 0.2 C represents 100%.

TABLE 1

| | | Coupling agent | | Nonaqueous solvent | | | Charge | Capac- | Rate |
|---|---|---|---|---|---|---|---|---|---|
| | | | Treatment | | Ratio | First | and | ity | char- |
| | | | amount | | (% | discharge | discharge | reten- | acter- |
| | Positive electrode | | (% by | | by | capacity | efficiency | tion | istics |
| | active material | Chemical formula | mass) | Type | volume) | (mAh/g) | (%) | rate (%) | (%) |
| Example 1 | LiNi_{0.5}Mn_{1.5}O₄ | CF₃CH₂CH₂Si(OCH₃)₃ | 0.7 | EC/DMC | 40/60 | 147.9 | 91.5 | 81.3 | — |
| Example 2 | LiNi_{0.5}Mn_{1.5}O₄ | CF₃(CF₂)₃CH₂CH₂Si(OCH₃)₃ | 0.7 | EC/DMC | 40/60 | 148.2 | 91.3 | 81.5 | — |
| Example 3 | LiNi_{0.5}Mn_{1.5}O₄ | CF₃(CF₂)₅CH₂CH₂Si(OCH₃)₃ | 0.7 | EC/DMC | 40/60 | 146.5 | 91.2 | 81.0 | — |
| Example 4 | LiNi_{0.5}Mn_{1.5}O₄ | CF₃(CF₂)₇CH₂CH₂Si(OCH₃)₃ | 0.7 | EC/DMC | 40/60 | 142.3 | 91.0 | 80.0 | — |
| Example 5 | LiNi_{0.5}Mn_{1.35}Ti_{0.15}O₄ | CF₃CH₂CH₂Si(OCH₃)₃ | 0.7 | EC/DMC | 40/60 | 148.4 | 91.8 | 81.4 | — |
| Example 6 | LiNi_{0.4}Co_{0.2}Mn_{1.4}O₄ | CF₃CH₂CH₂Si(OCH₃)₃ | 0.7 | EC/DMC | 40/60 | 147.0 | 91.3 | 80.5 | — |
| Example 7 | LiNi_{0.45}Fe_{0.1}Mn_{1.45}O₄ | CF₃CH₂CH₂Si(OCH₃)₃ | 0.7 | EC/DMC | 40/60 | 146.8 | 91.3 | 78.1 | — |
| Example 8 | LiNi_{0.5}Mn_{1.5}O₄ | CF₃CH₂CH₂Si(OCH₃)₃ | 0.7 | EC/DMC/FE1 | 30/50/20 | 150.2 | 92.4 | 82.7 | 75.1 |
| Example 9 | LiNi_{0.5}Mn_{1.5}O₄ | CF₃CH₂CH₂Si(OCH₃)₃ | 0.7 | EC/DMC/FE2 | 30/50/20 | 149.5 | 91.9 | 82.2 | 74.4 |
| Example 10 | LiNi_{0.5}Mn_{1.5}O₄ | CF₃CH₂CH₂Si(OCH₃)₃ | 0.7 | EC/DMC/FE3 | 30/50/20 | 148.7 | 92.0 | 81.8 | 73.5 |
| Example 11 | LiNi_{0.5}Mn_{1.5}O₄ | CF₃CH₂CH₂Si(OCH₃)₃ | 0.2 | EC/DMC | 40/60 | 138.8 | 90.9 | 78.9 | — |
| Example 12 | LiNi_{0.5}Mn_{1.5}O₄ | CF₃CH₂CH₂Si(OCH₃)₃ | 0.5 | EC/DMC | 40/60 | 146.3 | 91.0 | 80.2 | — |
| Example 13 | LiNi_{0.5}Mn_{1.5}O₄ | CF₃CH₂CH₂Si(OCH₃)₃ | 1.0 | EC/DMC | 40/60 | 147.1 | 91.7 | 81.0 | — |
| Example 14 | LiNi_{0.5}Mn_{1.5}O₄ | CF₃CH₂CH₂Si(OCH₃)₃ | 1.5 | EC/DMC | 40/60 | 144.7 | 91.0 | 80.5 | — |
| Example 15 | LiNi_{0.5}Mn_{1.5}O₄ | CF₃CH₂CH₂Si(OCH₃)₃ | 2.0 | EC/DMC | 40/60 | 139.7 | 91.2 | 78.8 | — |
| Example 16 | LiNi_{0.5}Mn_{1.5}O₄ | CF₃CH₂CH₂Si(OCH₃)₃ | 0.7 | EC/DMC/FE1 | 30/65/5 | 148.4 | 91.7 | 81.3 | 78.1 |
| Example 17 | LiNi_{0.5}Mn_{1.5}O₄ | CF₃CH₂CH₂Si(OCH₃)₃ | 0.7 | EC/DMC/FE1 | 30/60/10 | 150.1 | 92.0 | 82.1 | 76.5 |
| Example 18 | LiNi_{0.5}Mn_{1.5}O₄ | CF₃CH₂CH₂Si(OCH₃)₃ | 0.7 | EC/DMC/FE1 | 30/40/30 | 141.9 | 90.8 | 82.0 | 69.5 |
| Comparative | LiNi_{0.5}Mn_{1.5}O₄ | — | — | EC/DMC | 40/60 | 121.3 | 90.9 | 78.5 | — |
| Example 1 | | | | | | | | | |
| Comparative | LiNi_{0.5}Mn_{1.5}O₄ | SHCH₂CH₂CH₂Si(OCH₃)₃ | 0.7 | EC/DMC | 40/60 | 125.2 | 89.5 | 61.9 | — |
| Example 2 | | | | | | | | | |
| Comparative | LiNi_{0.5}Mn_{1.5}O₄ | NH₂CH₂CH₂CH₂Si(OCH₃)₃ | 0.7 | EC/DMC | 40/60 | 131.4 | 90.1 | 67.1 | — |
| Example 3 | | | | | | | | | |
| Comparative | LiNi_{0.5}Mn_{1.5}O₄ | CH₃Si(OCH₃)₃ | 0.7 | EC/DMC | 40/60 | 134.0 | 90.3 | 74.8 | — |
| Example 4 | | | | | | | | | |
| Comparative | LiNi_{0.5}Mn_{1.35}Ti_{0.15}O₄ | — | — | EC/DMC | 40/60 | 122.5 | 90.9 | 79.2 | — |
| Example 5 | | | | | | | | | |
| Comparative | LiNi_{0.4}Co_{0.2}Mn_{1.4}O₄ | — | — | EC/DMC | 40/60 | 121.3 | 90.5 | 78.5 | — |
| Example 6 | | | | | | | | | |
| Comparative | LiNi_{0.45}Fe_{0.1}Mn_{1.45}O₄ | — | — | EC/DMC | 40/60 | 120.5 | 90.0 | 76.3 | — |
| Example 7 | | | | | | | | | |
| Comparative | LiNi_{0.5}Mn_{1.5}O₄ | — | — | EC/DMC/FE1 | 30/50/20 | 132.2 | 91.5 | 79.8 | 70.1 |
| Example 8 | | | | | | | | | |
| Comparative | LiMn₂O₄ | — | — | EC/DMC | 40/60 | 104.3 | 95.5 | 93.0 | — |
| Example 9 | | | | | | | | | |
| Comparative | LiMn₂O₄ | CF₃CH₂CH₂Si(OCH₃)₃ | 0.7 | EC/DMC | 40/60 | 102.3 | 96.1 | 93.2 | — |
| Example 10 | | | | | | | | | |

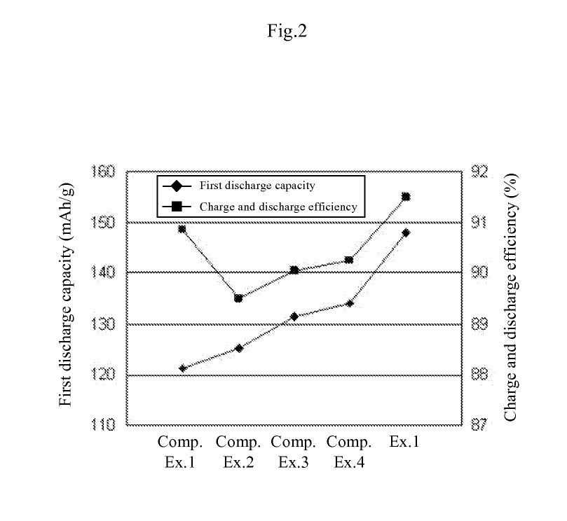

FIG. 2 is a graph showing the first discharge capacity and charge and discharge efficiency in Example 1 and Comparative Examples 1 to 4. As shown in FIG. 2, in Example 1 in which coupling treatment has been performed with a coupling agent containing fluorine, both the first discharge capacity and the charge and discharge efficiency were significantly improved as compared with Comparative Example 1 in which coupling treatment with a coupling agent has not been performed. The capacity retention rate was also significantly improved. However, in Comparative Examples 2 to 4 in which coupling treatment has been performed with a coupling agent containing no fluorine, the first discharge capacity was improved, but the charge and discharge efficiency was reduced, relative to Comparative Example 1. The capacity retention rate was also reduced.

On the other hand, when comparing Comparative Example 9 with Comparative Example 10, both using LiMn₂O₄ which is a 4 V-class positive electrode instead of the positive electrode active material A for a secondary battery which is a 5 V-class positive electrode, it has been verified that the first discharge capacity, charge and discharge efficiency, and capacity retention rate are not significantly improved even if a 4 V-class positive electrode is subjected to coupling treatment with a coupling agent containing fluorine.

Therefore, it has been found that when the positive electrode active material A for a secondary battery which is a 5 V-class positive electrode is subjected to coupling treatment with a coupling agent containing fluorine, both the charge and discharge characteristics and the cycle characteristics are improved. This is considered to be because the decomposition of the nonaqueous electrolytic solution and the elution of metal ions from the positive electrode are prevented by the formation of a film containing fluorine having a high oxidation resistance on at least a part of a surface of the positive electrode active material A for a secondary battery.

When Examples 1 to 4 were compared with Comparative Examples 1 to 4 for evaluating battery characteristics in the case of changing the number (n) of the CF₂ groups of a silane coupling agent having a fluorinated alkyl group represented by the formula (I), the resulting first discharge capacity, charge and discharge efficiency, and capacity retention rate in Examples 1 to 4 were higher than those in Comparative Examples 1 to 4. Thus, it has been verified that battery characteristics are improved by the surface modification of the positive electrode active material A for a secondary battery with a silane coupling agent having a fluorinated alkyl group, irrespective of the number of the CF₂ groups.

When Examples 5 to 7 in which a positive electrode active material A for a secondary battery whose composition has been changed by the introduction of a substitution element into LiNi_{0.5}Mn_{1.5}O₄ was subjected to coupling treatment with a coupling agent containing fluorine were compared with Comparative Examples 5 to 7, respectively, in which the same active material A was not subjected to coupling treatment with a coupling agent, the battery characteristics were improved by performing coupling treatment with a silane coupling agent containing fluorine, even when using any positive electrode active material A for a secondary battery of any composition. Thus, it has been verified that the effect of coupling treatment with a coupling agent containing fluorine is effective in 5 V-class positive electrodes in general, irrespective of the composition of the positive electrode active material A for a secondary battery.

When Example 1, Examples 11 to 15, and Comparative Example 1 were compared for evaluating battery characteristics in the case of changing the treatment amount of a coupling agent containing fluorine, the resulting battery characteristics in any Example were higher than those in Comparative Example 1. In particular, it has been verified that satisfactory battery characteristics are obtained when the treatment amount of the coupling agent containing fluorine is in the range of 0.5 to 1.5% by mass.

Examples 8 to 10 were compared with Comparative Example 8 and Example 1 for evaluating battery characteristics in the case when a nonaqueous electrolytic solution contains a fluorinated solvent. The battery characteristics have been further improved by mixing a fluorinated ether as a fluorinated solvent. This is considered to be because the oxidation resistance of a nonaqueous electrolytic solution is improved by mixing a fluorinated ether to suppress the decomposition of the nonaqueous electrolytic solution. This effect was effective also when the positive electrode active material A for a secondary battery was subjected to coupling treatment with a coupling agent containing fluorine. Furthermore, the Example in which the positive electrode active material was subjected to coupling treatment with a coupling agent containing fluorine had better rate characteristics than the untreated Comparative Example. This is considered to be because the compatibility of the film containing fluorine formed on at least a part of a surface of the positive electrode active material A for a secondary battery with a fluorinated ether is high. This compatibility is not limited to a fluorinated ether, but the same effect will probably be developed by any fluorinated solvent. Thus, it has been verified that battery characteristics can be further improved by combining a fluorinated solvent with the positive electrode active material A for a secondary battery which has been subjected to coupling treatment with a coupling agent containing fluorine.

When Example 8 and Examples 16 to 18 were compared for evaluating battery characteristics in the case of changing the mixing ratio of a fluorinated solvent, it has been verified that satisfactory battery characteristics are obtained particularly when the mixing ratio of the fluorinated solvent is in the range of 10 to 20% by mass.

This application claims the priority based on Japanese Patent Application No. 2010-276836 filed on Dec. 13, 2010, the disclosure of which is incorporated herein in its entirety.

Hereinabove, the present invention has been described with reference to the exemplary embodiment and Examples, but the present invention is not limited to the above exemplary embodiment and Examples. Various modifications which those skilled in the art can understand can be made to the constitution and details of the present invention within the scope of the present invention.

### REFERENCE SIGNS LIST

1 Positive Electrode Active Material Layer
2 Negative Electrode Active Material Layer
3 Positive Electrode Current Collector
4 Negative Electrode Current Collector
5 Separator
6 Laminated Outer Package
7 Negative Electrode Lead Terminal
8 Positive Electrode Lead Terminal

1. A positive electrode active material B for a secondary battery obtained by subjecting a positive electrode active material A for a secondary battery having a charge and discharge range of 4.5 V or more with respect to lithium metal to coupling treatment with a coupling agent comprising at least fluorine,
wherein the coupling agent is a silane coupling gent having a fluorinated alkyl group represented by the following formula (I):
CF₃(CF₂)ₙ(CH₂)₂—Si—(OR)₃ (I)
wherein n is an integer of 0 to 10; and R is —(CH₂)ₘCH₃, wherein m is an integer of 0 to 2, and
wherein the positive electrode active material A for a secondary battery is represented by the following formula (II):
Liₐ(MₓMn_{2-x-y}Y_{y})(O_{4-w}Z_{w}) (II)
wherein 0.5≦x≦1.2, 0≦y, x+y<2, 0≦a≦1.2, and 0≦w≦1; M is at least one selected from the group consisting of Co, Ni, Fe, Cr, and Cu; Y is at least one selected from the group consisting of Ti and Si; and Z is at least one of F and Cl.

2. (canceled)

3. (canceled)

4. The positive electrode active material B for a secondary battery according to claim 1, wherein M comprises at least Ni in the formula (II).

5. A positive electrode active material B for a secondary battery having a film at least comprising fluorine on at least a part of a surface of a positive electrode active material A for a secondary battery having a charge and discharge range of 4.5 V or more with respect to lithium metal,
wherein the positive electrode active material A for a secondary battery is represented by the following formula (II):
Liₐ(MₓMn_{2-x-y}Y_{y})(O_{4-w}Z_{w}) (II)
wherein 0.5≦x—1.2, 0≦y, x+y<2, 0≦a≦1.2, and 0≦w≦_{——} 1; M is at least one selected from the group consisting of Co, Ni, Fe, Cr, and Cu; Y is at least one selected from the group consisting of Ti and Si; and Z is at least one of F and Cl.

6. The positive electrode active material B for a secondary battery according to claim 5, wherein the film comprises silicon.

7. (canceled)

8. The positive electrode active material B for a secondary battery according to claim 5, wherein M comprises at least Ni in the formula (II).

9. A positive electrode for a secondary battery comprising a positive electrode active material B for a secondary battery according to any one of claims 1 to 8 claim 1.

10. A secondary battery comprising a positive electrode for a secondary battery according to claim 9.

11. The secondary battery according to claim 10, further comprising a nonaqueous electrolytic solution.

12. The secondary battery according to claim 11, wherein the nonaqueous electrolytic solution comprises a fluorinated solvent.

13. A method for producing a positive electrode active material B for a secondary battery comprising: mixing a positive electrode active material A for a secondary battery having a charge and discharge range of 4.5 V or more with respect to lithium metal with a treatment solution comprising a coupling agent comprising at least fluorine; and
drying the mixture,
wherein the coupling agent is a silane coupling agent having a fluorinated alkyl group represented by the following formula (I):
CF₃(CF₂)ₙ(CH₂)₂—Si—(OR)₃ (I)
wherein n is an integer of 0 to 10; and R is —(CH₂)ₘCH₃, wherein m is an integer of 0 to 2, and
wherein the positive electrode active material A for a secondary battery is represented by the following formula (II):
Liₐ(MₓMn_{2-x-y}Y_{y})(O_{4-w}Z_{w}) (II)
wherein 0.5≦x≦1.2, 0≦y, x+y<2, 0 ≦a≦1.2, and 0≦w≦1; M is at least one selected from the group consisting of Co, Ni, Fe, Cr, and Cu; Y is at least one selected from the group consisting of Ti and Si; and Z is at least one of F and Cl.

14. (canceled)

15. (canceled)

16. The method for producing the positive electrode active material B for a secondary battery according to claim 13, wherein M comprises at least Ni in the formula (II).

17. The secondary battery according to claim 12, wherein the fluorinated solvent is a fluorinated ether.

18. A positive electrode for a secondary battery comprising a positive electrode active material B for a secondary battery according to claim 5.

19. A secondary battery comprising a positive electrode for a secondary battery according to claim 18.

20. The secondary battery according to claim 19, further comprising a nonaqueous electrolytic solution.

21. The secondary battery according to claim 20, wherein the nonaqueous electrolytic solution comprises a fluorinated solvent.

22. The secondary battery according to claim 21, wherein the fluorinated solvent is a fluorinated ether.
